(19) United States
(12) Patent Application Publication
(10) Pub. No.: US 2026/0012224 A1
(43) Pub. Date: Jan. 8, 2026

(54) OPERATING METHOD OF WIRELESS POWER TRANSCEIVING SYSTEM, WIRELESS POWER RECEPTION DEVICE, AND OPERATING METHOD OF WIRELESS POWER RECEPTION DEVICE

(71) Applicant: SAMSUNG ELECTRONICS CO., LTD., Suwon-si (KR)

(72) Inventors: Youso Cheon, Suwon-si (KR); Donghyuk Choi, Suwon-si (KR); Seokhyeong Ham, Suwon-si (KR)

(21) Appl. No.: 19/020,898

(22) Filed: Jan. 14, 2025

(30) Foreign Application Priority Data
Jul. 3, 2024 (KR) 10-2024-0087814

(51) Int. Cl. H04B 5/79; H02J 50/12; H02J 50/80

(52) U.S. Cl. CPC H04B 5/79; H02J 50/12; H02J 50/80

(57) ABSTRACT

A method of operating a wireless power reception device configured to receive a data signal or wireless power from a wireless power transmission device may include receiving, by the wireless power reception device, an input signal from the wireless power transmission device, and determining, by the wireless power reception device, that the input signal is a data signal or a transmission power signal based on a polarity of the input signal with respect to a frequency change.

### CROSS-REFERENCE TO RELATED APPLICATION

This application claims priority under 35 U.S.C. § 119 to Korean Patent Application No. 10-2024-0087814, filed in the Korean Intellectual Property Office on Jul. 3, 2024, the disclosure of which is incorporated by reference herein in its entirety.

### BACKGROUND

For many people living in modern times, portable digital communication devices have become an essential element. Consumers want to be provided with a variety of high-quality services they want anytime, anywhere. In addition, due to the recent Internet of Thing (IoT), various sensors, home appliances, and communication devices that exist in our lives are connected to each other in one network. A wireless power transmission system is required to operate these various sensors smoothly.

Wireless power transmission includes magnetic induction, magnetic resonance, and electromagnetic wave methods. The magnetic induction or magnetic resonance method is advantageous for charging an electronic device located in a relatively short-distance to a wireless power transmission device. The electromagnetic wave method is more advantageous for long-distance power transmission up to several meters in comparison to the magnetic induction or magnetic resonance method. The electromagnetic wave method is mainly used for long-distance power transmission, and the electromagnetic wave method may most efficiently deliver power to a power receiver by identifying the exact location of the power receiver at a long distance.

### SUMMARY

In general, in some aspects, the present disclosure is directed toward a wireless power reception device that distinguishes a transmission power signal based on a frequency dithering operation of a wireless power transmission device from a data signal having modulated data.

According to some implementations, the present disclosure is directed to a method of operating a wireless power reception device receiving a data signal or wireless power from a wireless power transmission device may include receiving, by the wireless power reception device, an input signal from the wireless power transmission device, and determining, by the wireless power reception device, whether the input signal is a data signal or a transmission power signal based on a polarity of the input signal with respect to a frequency change.

According to some implementations, the present disclosure is directed to a method of operating a wireless power transceiving system including a wireless power transmission device and a wireless power reception device may include receiving, by a wireless power reception device, an input signal from the wireless power transmission device, and determining, by the wireless power reception device, whether the input signal is a data signal or a transmission power signal based on a polarity of the input signal with respect to a frequency change.

According to some implementations, the present disclosure is directed to a wireless power reception device receiving a data signal or wireless power from a wireless power transmission device may include a communication circuit receiving an input signal from the wireless power transmission device, and a frequency shift keying (FSK) detection module determining whether the input signal is a data signal or a transmission power signal based on a polarity of the input signal with respect to a frequency change.

### BRIEF DESCRIPTION OF THE DRAWINGS

Example implementations will be more clearly understood from the following detailed description, taken in conjunction with the accompanying drawings.

FIG. 1 is a diagram illustrating an example of a wireless power transceiving system according to some implementations.

FIG. 2 is a diagram illustrating an example of a wireless power transceiving system according to some implementations.

FIG. 3 is a diagram illustrating an example of a wireless power transmission device according to some implementations.

FIGS. 4, 5A, and 5B are diagrams illustrating an example of a frequency of transmission power based on a frequency dithering operation for EMI mitigation according to some implementations.

FIGS. 6A and 6B are diagrams illustrating an example of amplitude shift keying (ASK) and an example of frequency shift keying (FSK), respectively according to some implementations.

FIGS. 7A to 7C are diagrams illustrating an example of FSK modulation according to some implementations.

FIGS. 8 and 9 are block diagrams illustrating a wireless power transceiving system according to some implementations.

FIG. 10 is a flowchart illustrating an example of an operation of a wireless power transceiving system according to some implementations.

FIG. 11 is a flowchart illustrating an example operation S120 according to some implementations.

FIGS. 12A and 12B are graphs illustrating an example of a count value of a transmission power signal based on frequency dithering and an example of a count value of a data signal, respectively, according to some implementations.

FIG. 13 is a flowchart illustrating an example of an operation of a wireless power transceiving system according to some implementations.

### DETAILED DESCRIPTION

First, depending on the context, “power” or “wireless power” to be described below may refer to “wireless power” based on a non-contact manner. The term “wireless power” used below may refer to any form of energy related to an electric field, magnetic field, electromagnetic field, etc. transmitted from a wireless power transmitter to a wireless power receiver without the use of physical electromagnetic conductors. Wireless power may be referred to as a wireless power signal, or may mean an oscillating magnetic flux enclosed by a transmission coil and a reception coil. Non-contact manners may include, for example, methods of transferring power via magnetic coupling, methods of transferring power via radio frequency (RF), methods of transferring power via microwaves, and methods of transferring power via ultrasound.

In addition, depending on the context, for example, “transmission power” to be described below may refer to a “transmission power signal”. That is, “A power” may refer to an “A power signal” depending on the context.

In addition, a “power reception device” and a “power transmission device” to be described below refer to a “wireless power reception device” and a “wireless power transmission device”.

In addition, each of the “modules” described herein may correspond to hardware, software, or a combination of hardware and software included in a computing system. The hardware may include at least one of a programmable component, such as a central processing unit (CPU), a digital signal processor (DSP), a graphics processing unit (GPU), a reconfigurable component such as a field programmable gate array (FPGA), and a component that provides fixed functions such as an intellectual property (IP) block. The software may include at least one of a series of instructions executable by a programmable component and code convertible into a series of instructions by a compiler or the like, and may be stored in a non-transitory storage medium.

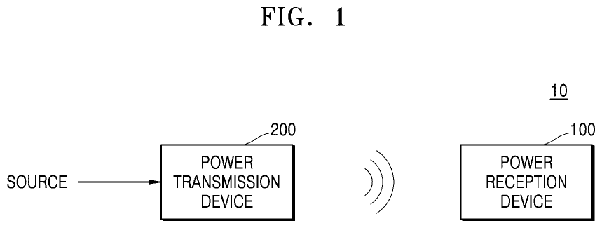

FIG. 1 is a diagram illustrating an example of a wireless power transceiving system according to some implementations. In FIG. 1, a wireless power transceiving system 10 may include a wireless power transmission device 200 and a wireless power reception device 100.

The wireless power transmission device 200 may supply wireless power to the wireless power reception device 100. In FIG. 1, the wireless power transmission device 200 receives power from an external power source SOURCE to generate a magnetic field. The wireless power reception device 100 wirelessly receives power from the wireless power transmission device 200 by generating a current using the generated magnetic field.

For example, the wireless power transmission device 200 may provide wireless power for the wireless power reception device 100 in a non-contact manner. The non-contact manner may be, for example, a wireless charging standard (e.g., Alliance for Wireless Power (A4WP)) that follows particular short-range wireless communication. However, the present disclosure is not limited thereto, and in another example, the non-contact manner may be a wireless charging standard (e.g., Wireless Power Consortium (WPC)), Power Matters Alliance (PMA) that does not use particular short-range wireless communication.

The wireless power transmission device 200 may not only transmit wireless power, but may also receive information data from the wireless power reception device 100 in a non-contact manner. For example, in the wireless power transceiving system 10, the wireless power transmission device 200 and the wireless power reception device 100 may transmit and receive various information necessary for wireless power transmission.

In FIG. 1, communication between the wireless power transmission device 200 and the wireless power reception device 100 may be performed according to either in-band communication using a magnetic field used for wireless power transmission or out-band communication using a separate communication carrier. The out-band communication may be referred to as out-of-band communication. For example, out-band communication may include near field communication (NFC), Bluetooth, Bluetooth low energy (BLE), etc.

In addition, each of the wireless power transmission device 200 and the wireless power reception device 100 may be referred to as an electronic device. Here, the electronic device according to various implementations may include at least one of, for example, a smartphone, a tablet personal computer (PC), a mobile phone, a video phone, an electronic book (e-book) reader, a desktop PC, a laptop PC, a netbook computer, a workstation, a server, a personal digital assistant (PDA), an MP3 player, a mobile medical device, a camera, or a wearable device (e.g., smart glasses, head-mounted-devices (HMDs), electronic clothing, electronic bracelets, electronic necklaces, electronic accessories, electronic tattoos, smart mirrors, or smart watches).

In some implementations, the electronic device may be a smart home appliance. Smart home appliances may include, for example, at least one of a television, a digital video disk (DVD) player, an audio device, a refrigerator, an air conditioner, a vacuum cleaner, an oven, a microwave oven, a washing machine, an air purifier, a set-top box, a home automation control panel, a security control panel, a TV box (e.g., Samsung HomeSync™, Apple TV™, or Google TV™), a game console (e.g., Xbox™ or PlayStation™), an electronic dictionary, an electronic key, a camcorder, or an electronic picture frame. In some implementations, the electronic device may include at least one of various medical devices (e.g., various portable medical measuring devices such as blood glucose meters, heart rate monitors, blood pressure monitors, or body temperature monitors), magnetic resonance angiography (MRA), magnetic resonance imaging (MRI), computed tomography (CT), cameras, or ultrasound devices, navigation devices, global positioning system (GPS) receivers, event data recorders (EDRs), a flight data recorders (FDRs), automobile infotainment devices, electronic equipment for ships (e.g., navigation devices for ships, gyro compasses, etc.), avionics, security devices, head units for vehicles, industrial or household robots, automatic teller's machines (ATMs) of financial institutions, point of sales (POS) of stores, or internet of things devices (e.g., light bulbs, various sensors, electric or gas meters, sprinkler devices, fire alarms, thermostats, streetlights, toasters, exercise equipment, hot water tanks, heaters, boilers, etc.).

According to some implementations, the electronic device may include at least one of a furniture or part of a building/structure, an electronic board, an electronic signature reception device, a projector, or various measuring devices (e.g., water, electricity, gas, or radio wave measuring devices). In some implementations, the electronic device may be one or a combination of two or more of the various devices described above. The electronic device may be a flexible electronic device. In addition, an electronic device is not limited to the devices described above, and may include a new electronic device according to technological development.

In some implementations, there may be one or more wireless power reception devices 100 in the wireless power transceiving system 10. In other words, in FIG. 1, the wireless power transmission device 200 and the wireless power reception device 100 are expressed as exchanging power one-to-one, but unlike the illustration in FIG. 1, a single wireless power transmission device 200 may transmit power to a plurality of wireless power reception devices 100.

In particular, when wireless power is provided through a magnetic resonance method, one wireless power transmitter 200 may simultaneously provide power to a plurality of wireless power reception devices 100 based on a simultaneous transmission method or a time division transmission method.

In addition, FIG. 1 shows that the wireless power transmission device 200 directly transfers power to the wireless power reception device 100, but a separate wireless power transceiving device, such as a relay or a repeater, may be provided between the wireless power transmission device 200 and the wireless power reception device 100. In this case, the wireless power transmission device 200 may provide power to the wireless power transceiving device, and the wireless power transceiving device may provide power to the wireless power reception device 100 again.

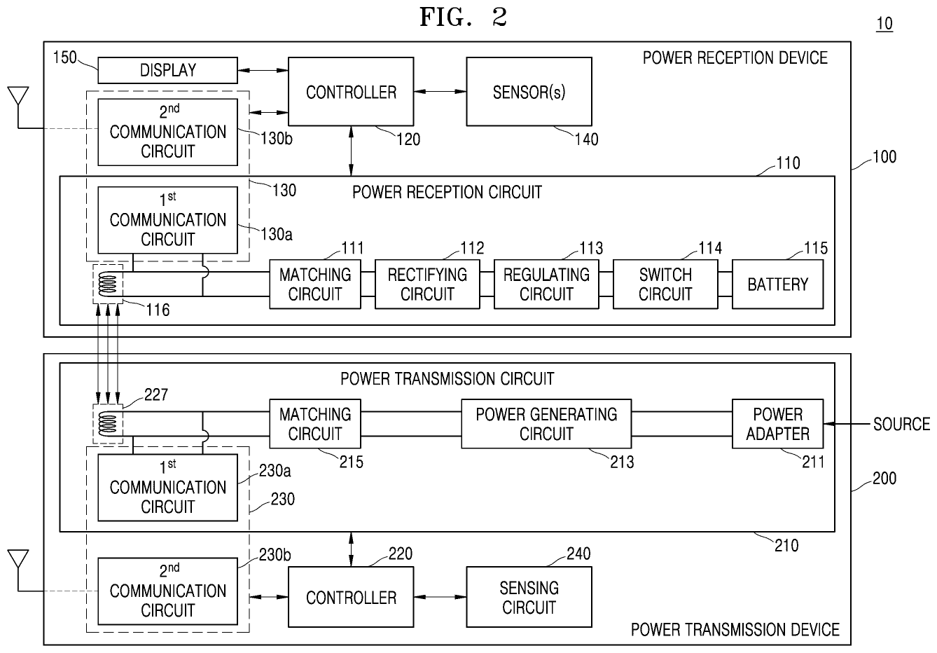

According to some implementations, the wireless power reception device 100 may clearly distinguish a transmission power signal based on a frequency dithering operation of the wireless power transmission device 200 for electromagnetic interference (EMI) mitigation from a data signal having modulated data. This will be described in detail with reference to FIGS. 2 to 15.

FIG. 2 is a diagram illustrating an example of a wireless power transceiving system according to some implementations. In FIG. 2, a power transmission device 200 may include a power transmission circuit 210, a controller 220, and a communication circuit 230.

In some implementations, the power transmission circuit 210 may include a power adapter 211 that receives power, as an input, from an external power source SOURCE and appropriately converts the voltage of the input power, a power generating circuit 213 that generates power, a matching circuit 215 that maximizes efficiency between a transmission coil 227 and a reception coil 116, and the transmission coil 227 that wirelessly provides power to the power reception device 100.

Here, the transmission coil 227 may be referred to as a primary coil, and the primary coil may generate an electromagnetic field using alternating-current (AC) power (or voltage or current). The primary coil may receive AC power (or voltage or current) of a specific frequency output across the power adapter 211, the power generating circuit 213, and the matching circuit 215, and may generate a magnetic field of a specific frequency. The magnetic field may be generated in a non-radial or radial manner, and the wireless power reception device 100 receives the same to generate a current. In other words, the primary coil may wirelessly provide power to the power reception device 100.

In FIG. 2, the transmission coil 227 may provide power to the reception coil 116 included in the wireless power reception device 100 in a non-contact manner. Here, the reception coil 116 may be referred to as a secondary coil, and the secondary coil may receive wireless power transmitted from the wireless power transmission device 200. The secondary coil may receive power using a magnetic field generated by the primary coil. Here, when a specific frequency is a resonance frequency, a magnetic resonance phenomenon occurs between the primary coil and the secondary coil so that power may be transmitted more efficiently.

In the magnetic inductive coupling method, the primary coil and the secondary coil may have any suitable shape, for example, a copper wire wound around a highly permeable formation such as ferrite or amorphous metal.

The transmission coil 227 may also be referred to as a transmitting coil, a primary core, a primary winding, a primary loop antenna, or the like. In addition, the reception coil 116 may be referred to as a receiving coil, a secondary core, a secondary winding, a secondary loop antenna, a pickup antenna, or the like.

When the magnetic resonance method is used, the transmission coil 227 and the reception coil 116 may be implemented in the form of a primary resonance antenna and a secondary resonance antenna, respectively. The resonance antenna may have a resonant structure including a coil and a capacitor. In this case, the resonance frequency of the resonance antenna may be determined by inductance of the coil and capacitance of the capacitor. Here, the coil may be formed in the form of a loop. In addition, a core may be arranged inside the loop. The core may include a physical core such as a ferrite core or an air core. Energy transfer between the primary resonance antenna and the secondary resonance antenna may be performed through a resonance phenomenon of a magnetic field. The resonance phenomenon refers to a phenomenon in which, when a near-field corresponding to the resonant frequency of one resonant antenna is generated and another resonance antenna is located nearby, the two resonance antennas are coupled to each other, resulting in high-efficiency energy transfer between the resonance antennas. When a magnetic field corresponding to the resonant frequency is generated between the first and second resonance antennas, a phenomenon occurs in which the first and second resonance antennas resonate with each other. Accordingly, the magnetic field generated from the primary resonance antenna is focused toward the secondary resonance antenna with higher efficiency than when the magnetic field is radiated into free space in the general case. Accordingly, energy may be transferred from the primary resonance antenna to the secondary resonance antenna with high efficiency.

The magnetic inductive coupling method may be implemented similarly to the magnetic resonance method, but the frequency of the magnetic field does not need to be a resonance frequency in this case. Instead, the magnetic inductive coupling method requires matching between the loops constituting the transmission coil 227 and the reception coil 116, and the spacing between the loops should be very close.

In some implementations, the controller 220 performs overall control of the power transmission device 200, and may generate and transmit various messages required for wireless power transmission to the communication circuit 230. In some implementations, the controller 220 may calculate the power (or the amount of power) to be transmitted to the wireless power reception device 100 based on the information received from the communication circuit 230. In some implementations, the controller 220 may control the power generating circuit 213 to transmit the power calculated by the transmission coil 227 to the power reception device 100.

In addition, the controller 220 may be implemented as software, hardware, or a combination of hardware and software.

In some implementations, the communication circuit 230 may include at least one of a first communication circuit 230a and a second communication circuit 230b. For example, the first communication circuit 230a may communicate with a first communication circuit 130a of the power reception device 100 using the same frequency as a frequency used by the transmission coil 227 for power transfer (e.g., in-band communication). In some implementations, the second communication circuit 230b may communicate with a second communication circuit 130b of the power reception device 100 using, for example, a frequency different from a frequency used by the transmission coil 227 for power transfer (e.g., out-band communication). For example, the second communication circuit 230b may obtain information related to a charging state (e.g., Vrec information, Iout information, various packets, messages, etc.) from the second communication circuit 130b using any one of various short-range communication methods such as Bluetooth, BLE, Wi-Fi, and NFC.

In some implementations, the power transmission device 200 may further include a sensing circuit 240 for sensing the temperature or movement of the power reception device 100.

In FIG. 2, the power reception device 100 may include a power reception circuit 110, a controller 120, and a communication circuit 130. The power reception circuit 110 may receive power from the power transmission circuit 210 of the wireless power transmission device 200. The power reception circuit 110 may be implemented in the form of a built-in battery, or may be implemented in the form of a power reception interface to receive power from the outside.

In some implementations, the power reception circuit 110 may include a matching circuit 111 that maximizes efficiency between the transmission coil 227 and the reception coil 116, a rectifying circuit 112 that rectifies the received AC power to DC power, a regulating circuit 113 that regulates a charging voltage, a switch circuit 114, a battery 115, and the reception coil 116 that wirelessly receives power from the power transmission device 200.

The power reception circuit 110 may receive, through the reception coil 116, transmission power in the form of an electromagnetic wave generated in response to a current or voltage applied to the transmission coil 227 of the power transmission circuit 210. For example, the power reception circuit 110 may receive power using an induced electromotive force formed in the transmission coil 227 of the power transmission circuit 210 and the reception coil 116 of the power reception circuit 110.

The matching circuit 215 may perform impedance matching. For example, the power transmitted through the transmission coil 227 of the power transmission device 200 may be transmitted to the reception coil 116 to form an electromagnetic field. The matching circuit 111 may adjust the frequency band of the electromagnetic field signal formed by adjusting the impedance. The matching circuit 111 may control the input power received from the power transmission device 200 through the reception coil 116 to have high efficiency and high output by such impedance adjustment. The matching circuit 111 may adjust the impedance based on the control by the controller 120. The matching circuit 111 may include at least one of an inductor (e.g., a coil), a capacitor, and a switch device. The controller 120 may control a connection state with at least one of the inductor and the capacitor through the switch device, and accordingly, impedance matching may be performed.

The rectifying circuit 112 may rectify wireless power received by the reception coil 111 in a direct-current (DC) form, and may be implemented, for example, in the form of a bridge diode.

The regulating circuit 113 may convert the rectified power to a set gain. The regulating circuit 113 may include a DC/DC converter (not shown). For example, the regulating circuit 113 may convert the rectified power such that the voltage of the output terminal becomes 5 V. In some implementations, the minimum or maximum value of a voltage that may be applied to a front end of the regulating circuit 113 may be set.

The switch circuit 114 may connect the regulating circuit 113 to the battery 115. The switch circuit 114 may maintain a turn-on state or a turn-off state under the control by the controller 120.

The battery 115 may be charged by receiving power input from the regulating circuit 113.

In some implementations, the controller 120 performs overall control of the power reception device 100, and may generate and transmit various messages required for wireless power transmission to the communication circuit 130. In addition, the controller 120 may be implemented as software, hardware, or a combination of hardware and software.

In some implementations, the communication circuit 130 may include at least one of the first communication circuit 130a and the second communication circuit 130b. The first communication circuit 130a may communicate with the power transmission device 200 through the reception coil 116. The second communication circuit 130b may communicate with the power transmission device 200 by using any one of various short-range communication schemes such as Bluetooth, BLE, Wi-Fi, and NFC.

In some implementations, the power reception device 100 may further include at least one sensor 140, such as a current/voltage sensor, a temperature sensor, an illumination sensor, a sound sensor, and the like, and a display 150.

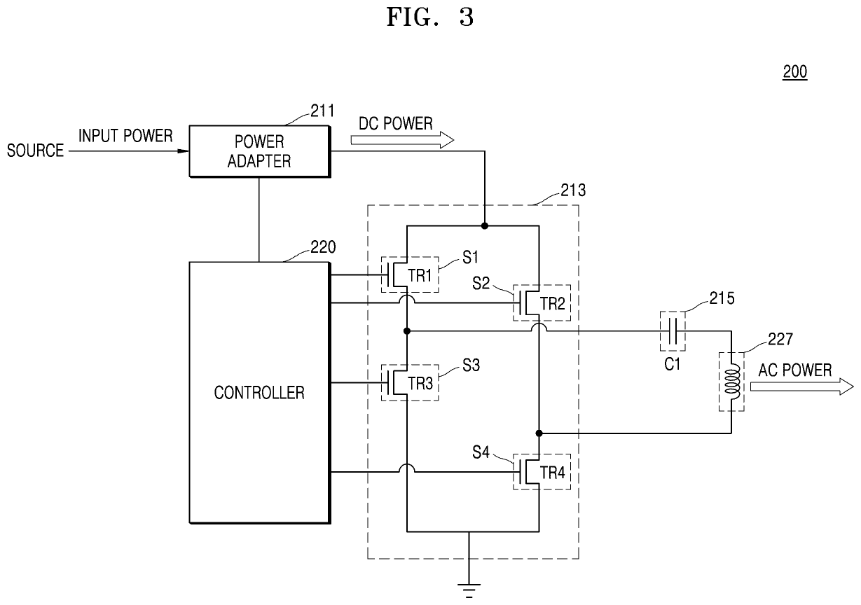

In addition, the wireless power transmission device 200 may perform a frequency dithering operation for EMI mitigation. This will be described in detail with reference to FIGS. 3 to 5.

FIG. 3 is a diagram illustrating an example of a wireless power transmission device according to some implementations. In the following, the redundant description of FIG. 3 to the description with reference to FIGS. 1 and 2 will be omitted. In FIG. 3, a power transmission device 200 may include a power adapter 211, a power generating circuit 213, a matching circuit 215, a transmission coil 227, a controller 220, and the like. The power adapter 211 is connected to an external power source line SOURCE (or a power supply device) and may receive input power INPUT POWER from the power source line. The power source line SOURCE may be referred to as a power line.

The power transmission device 200 may further include a power supply device. In some implementations, the power supply device may convert AC power into DC power and transmit the DC power to the power adapter 211. However, the present disclosure is not limited thereto, and in other implementations, the power supply device may be a component included in the power adapter 211.

In addition, the power adapter 211 may be referred to as an interface. In some implementations, the interface may include a power line and a data line.

The power adapter 211 may provide the input power INPUT POWER to the controller 220 and the power generating circuit 213.

The power generating circuit 213 may be implemented as a DC-AC conversion circuit. In FIG. 3, the power generating circuit 213 may include a full bridge circuit including four switches. However, the present disclosure is not limited thereto, and the power generating circuit 213 may be configured as a half bridge circuit.

In some implementations, the power generating circuit 213 may receive a control signal from the controller 220 and convert DC power into AC power based on the received control signal. For example, when a control signal with a logic high level is applied to the gate of a switch S1 and the gate of a switch S4, and a control signal with a logic low level is applied to the gate of a switch S2 and the gate of a switch S3, the switch S1 and the switch S4 may be turned on and the switch S2 and the switch S3 may be turned off. When the switch S1 and the switch S4 are turned on and the switch S2 and the switch S3 are turned off, the power generating circuit 213 may output power having the same sign as a sign of DC power input to the power generating circuit 213 from the power adapter 211. For example, when the DC power input from the power adapter 211 to the power generating circuit 213 has a positive sign, a positive voltage may be output between the source of the switch S1 (or the drain of the switch S3) and the drain of the switch S4 (or the source of the switch S2).

For example, when a control signal with a logic low level is applied to the gate of a switch S1 and the gate of a switch S4, and a control signal with a logic high level is applied to the gate of a switch S2 and the gate of a switch S3, the switch S1 and the switch S4 may be turned off and the switch S1 and the switch S4 may be turned on. When the switch S1 and the switch S4 are turned off and the switch S2 and the switch S3 are turned on, the power generating circuit 213 may output power having the opposite sign to a sign of DC power input to the power generating circuit 213 from the power adapter 211.

As the switches S1, S2, S3, and S4 periodically perform turn-on and turn-off operations, the power generating circuit 213 may convert DC power into AC power.

Although FIG. 3 illustrates that each of the switches includes an n-channel metal oxide semiconductor field effect transistor (NMOSFET), the present disclosure is not limited thereto. For example, each of the switches may include a switching element, such as a FET, a bipolar junction transistor (BJT), a diode, or the like other than the NMOSFET.

In some implementations, the matching circuit 215 may maximize efficiency between the transmission coil 227 and the reception coil 116, and may include a matching device. In FIG. 2, the matching circuit 215 is implemented as a capacitor C1, but the present disclosure is not limited thereto. For example, in some implementations, the matching circuit 215 may include a device such as an inductor or a resistor other than the capacitor C1.

The transmission coil 227 may transmit power to the reception coil 116 of the power reception device 100. In some implementations, the transmission coil 227 may include a conductive material.

The controller 220 may perform overall control of the power transmission device 200.

In FIG. 3, the power transmission device 200 that wirelessly transmits power by an electromagnetic inductive coupling method, but the present disclosure is not limited thereto. For example, some implementations, which will be described below, may be applied equally or similarly to a wireless power transfer electromagnetic resonance method or an electromagnetic wave method.

In addition, organizations such as the federal communications commission (FCC) have distributed regulations related to EMI of electric or magnetic fields, and wireless power transmission devices 200 must comply with the relevant regulations. In addition, wireless charging-related standards (e.g., WPC standards or A4WP standards) also regulate the maximum or minimum transmission amount, and the wireless power transmission devices 200 must comply with the regulations.

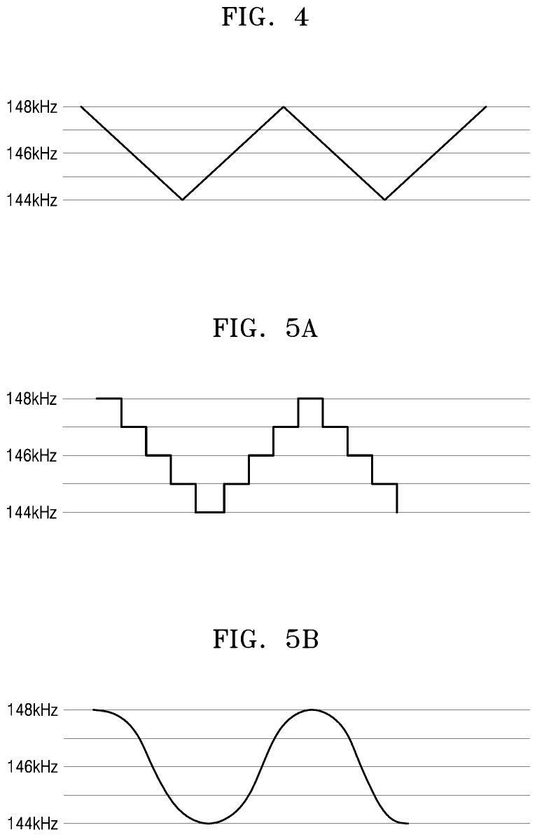

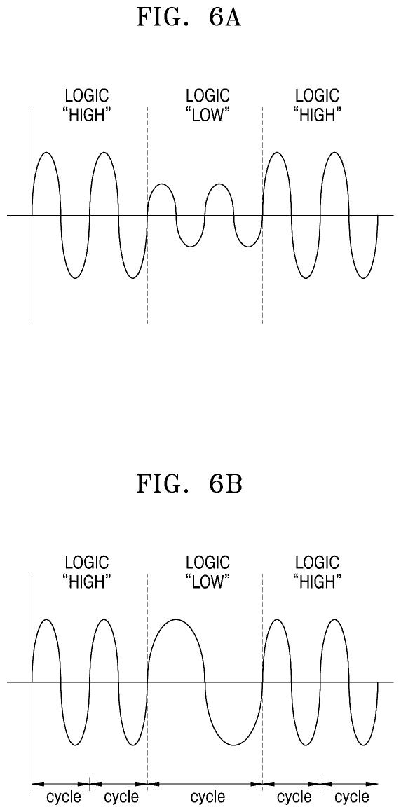

Hereinafter, the frequency dithering operation of the wireless power transmission device 200 to comply with international standards (e.g., WPC standard (Qi), A4WP standard, EN 300-330 standard) and reduce adverse effects on the human body due to EMI of electric or magnetic fields will be described in detail with reference to FIGS. 4 and 5.

In the present disclosure, “frequency dithering operation” is a type of EMI mitigation operation, and refers to an operation in which the power transmission device 200 repeatedly decreases and increases (or increases and decreases) the frequency of the transmission power within a range between a first frequency and a second frequency, thereby providing power to the power reception device 100. Here, frequency dithering may mean repetition of an operation of decreasing or increasing a frequency.

For example, the power transmission device 200 may provide transmission power having a frequency that changes in a specified range (or a specified frequency range) to the power reception device 100.

In some implementations, by adjusting the frequency, phase, or duty cycle of the control signal controlling the power generating circuit 213, the power transmission device 200 may provide transmission power having a frequency that changes in a specified range (or a specified frequency range) to the power reception device 100. For example, the controller 220 may adjust the frequency, phase, or duty cycle of the control signal with respect to the turn-off/turn-on of the switches S1, S2, S3, and S4 of the power generating circuit 213, and thus, the transmission coil 227 may provide transmission power having a frequency that changes in a specified range (or a specified frequency range) to the reception coil 116 of the power reception device 100.

Hereinafter, transmission power having a frequency that changes in a specified range (or a specified frequency range) will be described with reference to FIGS. 4 and 5.

FIGS. 4, 5A, and 5B are diagrams illustrating an example of a frequency of transmission power based on a frequency dithering operation for EMI mitigation according to some implementations. In FIG. 4, the power transmission device 200 may provide the power reception device 100 with transmission power with a frequency that repeatedly decreases and increases (or increases and decreases) between the upper-limit frequency (e.g., 148 kHz) and the lower-limit frequency (e.g., 144 kHz) in the specified frequency range. For example, the power transmission device 200 may provide the power reception device 100 with transmission power having a frequency that decreases and increases (or increases and decreases) based on a reference frequency (e.g., 146 kHz).

By performing the frequency dithering operation described above by the power transmission device 200, it is possible to prevent EMI higher than or equal to a reference value by a harmonic frequency of a fundamental frequency of transmission power. For example, when the power transmission device 200 does not perform (or use) frequency dithering operations, in the amount of conductive emission (or radioactive emission amount) according to the frequency change of the transmission power, the power transmission device 200 may output a conductive emission amount exceeding the reference value (or reference range) in some of the entire frequency range of the transmission power.

In addition, when the power transmission device 200 performs a frequency dithering operation, the power transmission device 200 may output a conductive emission amount that does not exceed a reference value (or a reference range) in some frequency ranges of the transmission power described above. Here, the conductive emission amount may be based on a frequency change of the transmission power.

Although FIG. 4 illustrates that the frequency of the transmission power linearly decreases and increases, the present disclosure is not limited thereto. In some implementations, as shown in FIG. 5A, the frequency of the transmission power may decrease and increase (or increase and decrease) stepwise (or in stages) at regular time intervals. In another embodiment, as shown in FIG. 5B, the frequency of the transmission power may decrease and increase (or increase and decrease) in the form of a sine wave.

In addition, even when a specific packet for data transmission is not transmitted, the power transmission device 200 may provide the power reception device 100 with transmission power having a frequency that changes in a designated range (or a designated frequency range) for EMI mitigation.

Although the power transmission device according to a comparative example has no intention of transmitting data, the power reception device according to the comparative example determines the transmission power signal as a data signal in which data is modulated based on a frequency change of the transmission power signal by a frequency dithering operation, thereby allowing the power reception device according to the comparative example to terminate receiving wireless power corresponding to the transmission power signal and perform a decoding operation on the transmission power signal.

At the same time, based on determining the transmission power signal as the data-modulated data signal, the power reception device according to the comparative example may end providing a packet according to the wireless power reception to the power transmission device according to the comparative example. Accordingly, in response to not receiving the packet according to the wireless power reception of the power reception device according to the comparative example within a preset time range, the power transmission device according to the comparative example may end providing transmission power to the power reception device.

In other words, the power reception device according to the comparative example misrecognizes the transmission power signal based on the frequency dithering operation as the data-modulated data signal, and the power reception device according to the comparative example may perform an incorrect data decoding operation and may not receive the required transmission power.

For example, the power reception device needs to clearly distinguish between the transmission power signal based on the frequency dithering operation of the power transmission device and the data signal in which data is modulated.

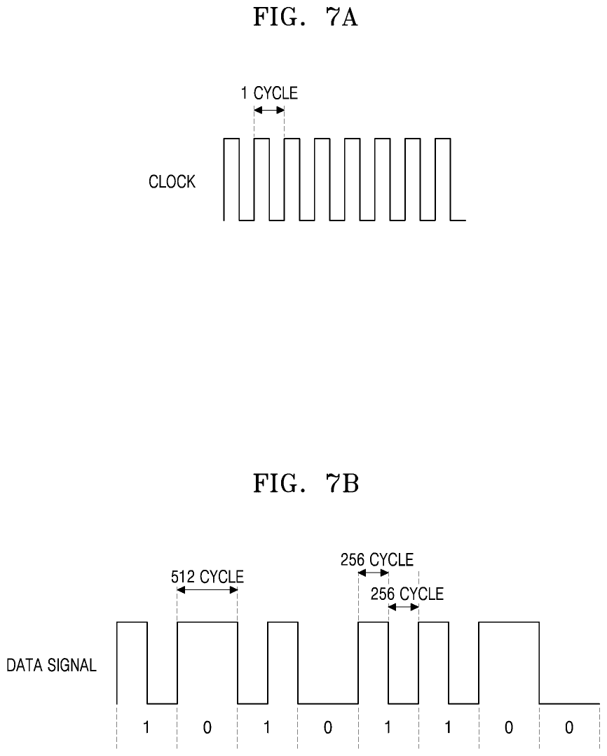

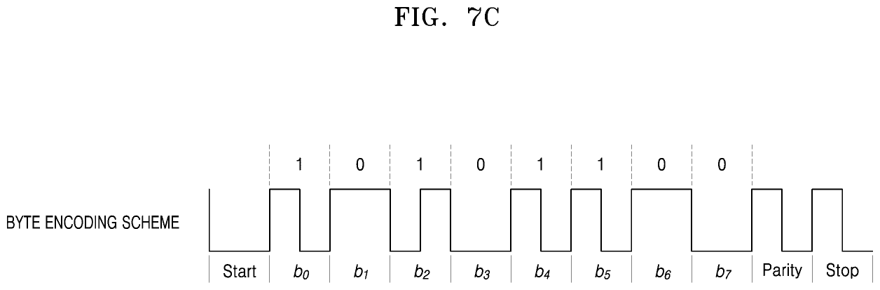

The power reception device 100 needs to clearly distinguish between the transmission power signal based on the frequency dithering operation of the power transmission device and the data signal in which data is modulated. Hereinafter, a method of distinguishing between a transmission power signal based on a frequency dithering operation from a data signal in which data is modulated by the power reception device 100 of an embodiment is described in detail. First, a method of generating a modulated data signal is described in detail with reference to FIGS. 6 and 7.

FIGS. 6A and 6B are diagrams illustrating an example of amplitude shift keying (ASK) and an example of FSK, respectively, according to some implementations.

There are two types of wireless power transceiving methods, such as (1) a magnetic inductive coupling method using a magnetic inductive coupling phenomenon between a reception coil and a transmission coil and (2) a magnetic resonance method using a magnetic resonance phenomenon by resonance frequency. Here, the A4WP council defines the wireless charging standard for the magnetic resonance method, and the WPC defines the wireless charging standard for the magnetic inductive coupling method.

In addition, according to the wireless charging standard (e.g., Qi) for a magnetic inductive coupling method of the WPC, various pieces of status information and instructions related to the wireless power transceiving system are defined to be exchanged in band.

In addition, according to the wireless charging standard (e.g., Qi) for the magnetic inductive coupling method of WPC, the data signal provided by the power transmission device 200 to the power reception device 100 is defined as a signal modulated according to the ASK, and the data signal provided by the power reception device 100 to the power transmission device 200 is defined as a signal modulated according to the FSK.

For example, the power transmission device 200 may provide the power reception device 100 with a data signal modulated according to the FSK for data communication. In addition, the power reception device 100 may provide the power transmission device 200 with a data signal modulated according to the ASK for data communication.

In FIG. 6A, the power reception device 100 may provide a data signal to the power transmission device 200 by encoding data expressed in bit values as the data signal so that logic high (e.g., 1) has a relatively large amplitude and logic low (e.g., 0) has a relatively small amplitude.

In FIG. 6B, the power transmission device 200 may provide a data signal to the power reception device 100 by encoding data expressed in bit values as the data signal so that logic high (e.g., 1) has a relatively large frequency and logic low (e.g., 0) has a relatively small frequency for a preset time interval.

FIGS. 7A to 7C are diagrams illustrating an example of FSK modulation according to some implementations. The power transmission device 200 may perform encoding using differential bi-phase encoding. Here, differential bi-phase encoding refers to encoding data into data signals to represent bit values according to the number of transitions of data signals within a predetermined time interval.

In FIG. 7A, the power transmission device 200 (in FIG. 3) may include a clock signal generator that generates a clock signal CLOCK. In FIG. 7B, a data signal having a transition in 512 cycles of the clock signal CLOCK may indicate a bit value of 0, and a data signal having two transitions in 512 cycles of the clock signal CLOCK may indicate a bit value of 1. For example, one transition in 256 cycle units of the clock signal CLOCK in the data signal may represent a bit value of 1, and one transition in 512 cycle units of the clock signal CLOCK may represent a bit value of 0. Here, the interval unit of the clock signal CLOCK for representing the bit value is not limited to 512 or 256, and may be variously set according to embodiments.

In FIG. 7C, a byte encoding scheme according to an embodiment may include a total of 11 bits. Here, 11 bits may include a 1-bit start bit, an 8-bit data bit, a 1-bit parity bit, and a 1-bit stop bit. In addition, the bit value of the start bit may be 0, and the data bit may be expressed as a least significant bit (LSB) first order. When the number of bit values of 1 included in the data bit is even, the bit value of the parity bit may be 1, and when the number of bit values of 1 included in the data bit is odd, the bit value of the parity bit may be 0. In addition, a bit value of the stop bit may be 1.

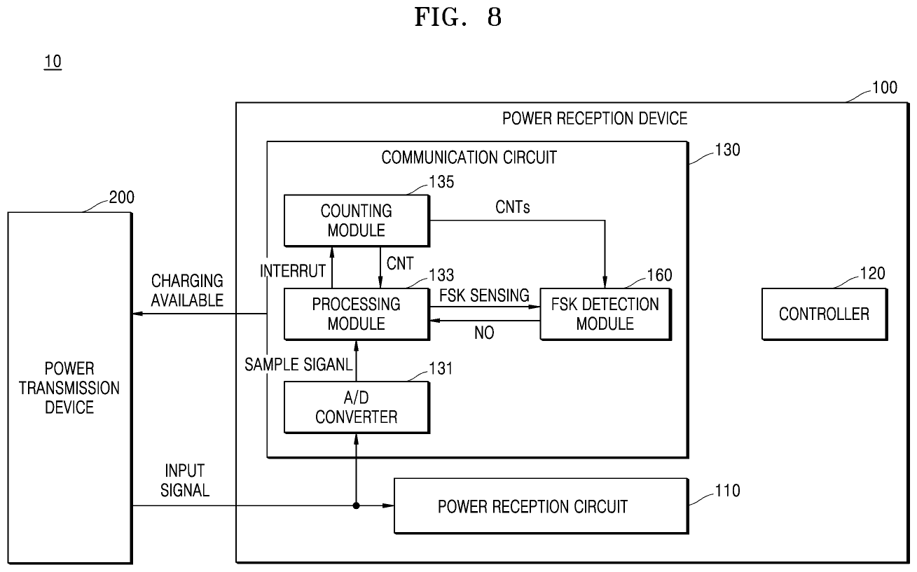

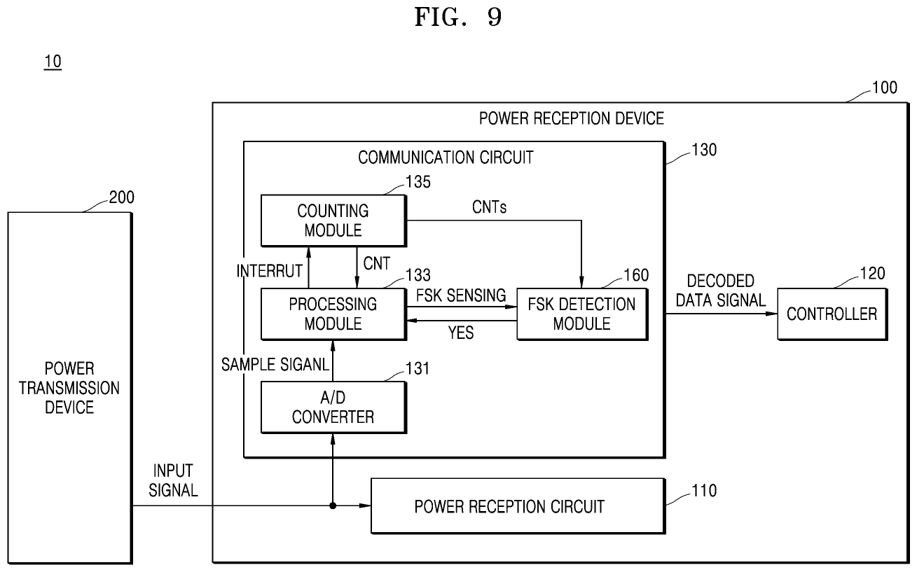

FIGS. 8 and 9 are block diagrams illustrating a wireless power transceiving system according to some implementations. In FIGS. 8 and 9, some of the components of FIG. 2 are omitted, but the present disclosure is not limited thereto, and the omitted components may be included according to some implementations.

In FIGS. 8 and 9, the power reception device 100 may further include an FSK detection circuit (module) 160. Although FIGS. 8 and 9 show that the FSK detection circuit 160 is included in the communication circuit 130, the present disclosure is not limited thereto, and the FSK detection circuit 160 may be included in the controller 120 of the power reception device 100, or may be configured as a single device in addition to the controller 120 or the communication circuit 130. In addition, the FSK detection circuit 160 may be included in a processing module 133. Here, the FSK detection circuit 160 may be implemented as software, hardware, or a combination of hardware and software. Furthermore, the communication circuit 130 of FIGS. 8 and 9 may correspond to at least one of the first communication circuit 130a or the second communication circuit 130b described with reference to FIG. 2.

In FIGS. 8 and 9, the power reception device 100 may distinguish, based on the FSK detection circuit 160, a transmission power signal based on a frequency dithering operation and a data signal in which data is modulated. The power reception device 100 may receive an input signal from the wireless power transmission device 200. Here, the input signal may be a data signal or a wireless power signal.

Based on a polarity of the input signal with respect to a frequency change, the FSK detection circuit 160 may determine whether the input signal is a transmission power signal based on a frequency dithering operation of the power transmission device 200 or a data signal.

Here, the polarity with respect to the frequency change may refer to a sign of a change amount between a previous frequency and a corresponding frequency of an input signal. In other words, a change amount of a corresponding frequency with respect to a previous frequency equals the corresponding frequency less the previous frequency, where, when the change amount of the corresponding frequency with respect to the previous frequency is positive, the polarity is positive (+), and when the change amount of the corresponding frequency with respect to the previous frequency is negative, the polarity is negative (−).

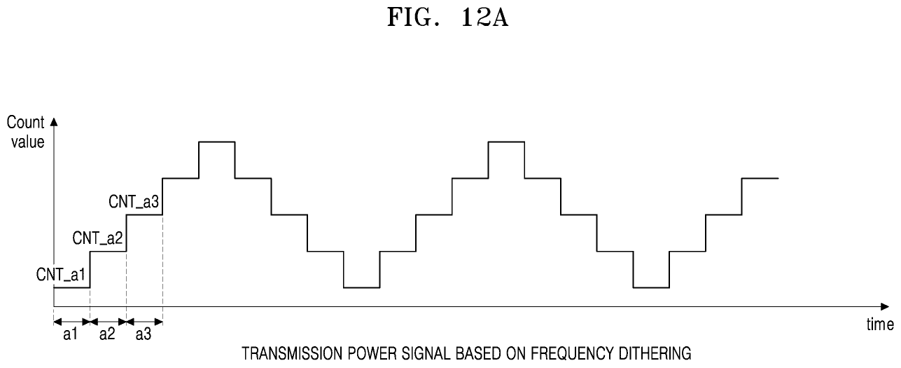

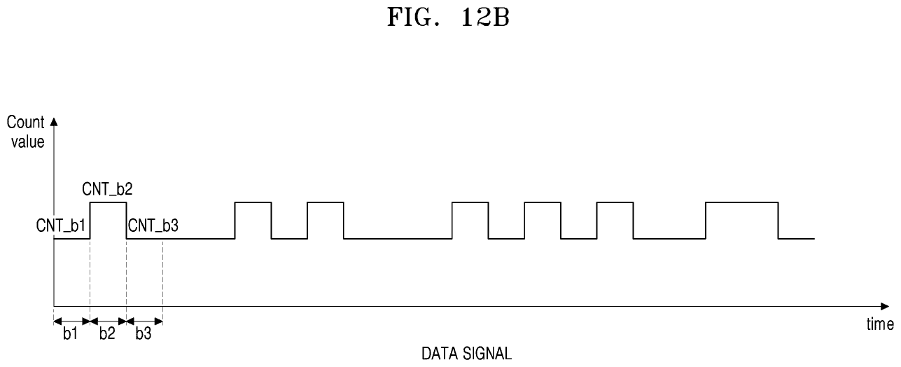

Based on a polarity of the input signal with respect to a frequency change, a method of, by the FSK detection circuit 160, determining whether the input signal is a transmission power signal based on a frequency dithering operation of the power transmission device 200 or a data signal, is described in detail with reference to FIGS. 11 and 12.

In addition, the power reception device 100 (e.g., the communication circuit 130) may generate a count value corresponding to the frequency of the input signal within a preset time interval unit.

In FIGS. 8 and 9, the communication circuit 130 may include an analog-to-digital (A/D) converter 131, the processing circuit (module) 133, and a counting circuit (module) 135. Here, the processing circuit 133 and the counting circuit 135 may be implemented as a single microcontroller unit (MCU). However, the present disclosure is not limited thereto, and each of the processing circuit 133 and the counting circuit 135 may be implemented as software, hardware, or a combination of hardware and software. Specifically, the A/D converter 131 may acquire a digital sample signal SAMPLE SIGNAL by receiving an analog input signal INPUT SIGNAL and sampling the received input signal INPUT SIGNAL.

The processing circuit 133 may receive the sample signal SAMPLE SIGNAL and generate an interrupt INTERRUPT each time a rising edge or a falling edge is detected in the sample signal SAMPLE SIGNAL.

The counting circuit 135 may generate a count value CNT by counting the number of interrupts INTERRUPT generated within a preset time interval unit.

For example, since the count value CNT corresponds to the frequency of the input signal INPUT SIGNAL within the preset time interval unit, the power reception device 100 may detect a frequency change of the input signal by calculating a difference between successive count values.

In some implementations, the processing circuit 133 and the counting circuit 135 may generate the count value CNT based on a pulse count decoding method that counts the number of points at which the sample signal SAMPLE SIGNAL intersects 0 or a timing decoding method that measures a time interval between points at which the frequency of the sample signal SAMPLE SIGNAL changes.

In addition, the processing circuit 133 may restore the original digital data by decoding the input signal (e.g., FSK modulated signal) based on the difference in successive count values. For example, the processing circuit 133 may convert a difference between consecutive count values to a bit value of 1 if the difference between consecutive count values is greater than or equal to a threshold value, and may convert the difference between consecutive count values to a bit value of 0 if the difference between consecutive count values is less than the threshold value. In addition, referring to FIG. 9, the communication circuit 130 may provide the controller 120 with a decoded data signal DECODED DATA SIGNAL.

In addition, the power reception device 100 may further include a clock signal generator (not shown) for generating a clock signal, and may generate a count value CNT for the input signal INPUT SIGNAL for each preset time interval unit by sampling the input signal INPUT SIGNAL and accumulating the sampling results in synchronization with the clock signal.

In addition, the processing circuit 133 may notify the FSK detection circuit 160 of FSK sensing for the input signal INPUT SIGNAL by detecting the frequency change of the input signal based on the difference in successive count values. For example, referring to FIGS. 8 and 9, the processing circuit 133 may provide the FSK detection circuit 160 with an FSK sensing message FSK SENSING for the input signal INPUT SIGNAL.

In response to the FSK sensing message FSK SENSING, based on the counting values CNTs, the FSK detection circuit 160 may determine whether the input signal INPUT SIGNAL is a transmission power signal based on a frequency dithering operation of the power transmission device 200 or a data signal. Based on the counting values CNTs, a method of, by the FSK detection circuit 160, determining whether the input signal INPUT SIGNAL is a transmission power signal based on a frequency dithering operation of the power transmission device 200 or a data signal, is described in detail with reference to FIGS. 11 and 12.

In FIG. 8, when the input signal INPUT SIGNAL is a transmission power signal based on a frequency dithering operation of the power transmission device 200, the FSK detection circuit 160 may provide the processing circuit 133 with a message NO that is “not FSK”. In response to the message NO, the processing circuit 133 may terminate the FSK decoding operation with respect to the input signal INPUT SIGNAL (or the sample signal SAMPLE SIGNAL). In addition, the power reception device 100 may continuously provide a pre-promised message CHARGING AVAILABLE to the power transmission device 200 during wireless power reception, and the power transmission device 200 may continue to provide wireless power to the power receiving circuit 110. Here, the message CHARGING AVAILABLE may be a message notifying the power transmission device 200 that the power reception device 100 is in a chargeable state, and the power reception device 100 may provide the message CHARGING AVAILABLE to the power transmission device 200 every preset interval during wireless power reception.

In FIG. 9, when the input signal INPUT SIGNAL is a data signal, the FSK detection circuit 160 may provide a message YES indicating “FSK is correct” to the processing module 133. In response to the message YES, the processing circuit 133 may not terminate the FSK decoding operation with respect to the input signal INPUT SIGNAL (or the sample signal SAMPLE SIGNAL). For example, the processing circuit 133 may continuously perform the FSK decoding operation on the input signal INPUT SIGNAL (or the sample signal SAMPLE SIGNAL), and the communication circuit 130 may provide the decoded data signal DECODED DATA SIGNAL to the controller 120. In addition, the power reception device 100 may not provide the power transmission device 200 with a pre-promised message CHARGING AVAILABLE during wireless power reception in order to stably perform the FSK decoding operation for the input signal INPUT SIGNAL (or the sample signal SAMPLE SIGNAL). As the power transmission device 200 does not receive the message CHARGING AVAILABLE within the preset time interval, the power transmission device 200 may end the providing of wireless power to the power reception circuit 110.

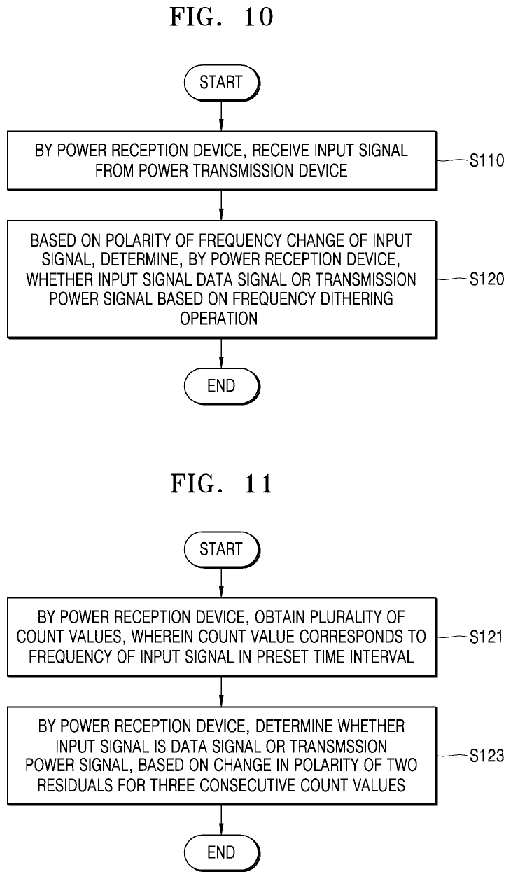

FIG. 10 is a flowchart illustrating an example of an operation of a wireless power transceiving system according to some implementations. In FIGS. 8 to 10, in the start operation, the power reception device 100 may already be receiving wireless power from the power transmission device 200. However, the present disclosure is not limited thereto, and the power reception device 100 may be in a state before receiving wireless power from the power transmission device 200.

In FIGS. 8 to 10, in operation S110, the power reception device 100 may receive an input signal INPUT SIGNAL from the power transmission device 200. Here, the input signal INPUT SIGNAL may be a data signal of the power transmission device 200 or a transmission power signal based on a frequency dithering operation of the power transmission device 200.

In FIGS. 8 to 10, in operation S120, the power reception device 100 may determine, based on a polarity of the input signal INPUT SIGNAL with respect to a frequency change, whether the input signal INPUT SIGNAL is a data signal or a transmission power signal based on a frequency dithering operation of the wireless power transmission device 200. Here, the polarity with respect to the frequency change may refer to a sign of a change amount between a previous frequency and a corresponding frequency of an input signal. In other words, a change amount of a corresponding frequency with respect to a previous frequency equals the corresponding frequency-the previous frequency, where, when the change amount of the corresponding frequency with respect to the previous frequency is positive, the polarity is positive (+), and when the change amount of the corresponding frequency with respect to the previous frequency is negative, the polarity is negative (−).

FIG. 11 is a flowchart illustrating an example of an operation S120 according to some implementations. FIGS. 12A and 12B are graphs illustrating an example of a count value of a transmission power signal based on frequency dithering and an example of a count value of a data signal, respectively, according to some implementations.

Operation S120 of FIG. 10 may include operations S121 and S123. Operations S121 and S123 may be performed by the FSK detection circuit 160 of FIGS. 8 and 9.

In operation S121, the power reception device 100 may obtain a plurality of count values. Here, the count value may correspond to a frequency of the input signal INPUT SIGNAL in a preset time interval.

The power reception device 100 may determine whether the input signal INPUT SIGNAL is a data signal or a transmission power signal based on a frequency dithering operation of the wireless power transmission device 200 based on a polarity change of two residual values for three consecutive count values. Here, a frequency may correspond to a count value, and a change amount of a corresponding frequency with respect to a previous frequency may correspond to a residual values. In other words, a residual value equals a corresponding frequency less a previous frequency, where, when a change amount of the corresponding frequency with respect to the previous frequency is positive, the polarity of the residual value is positive (+), and when the change amount of the corresponding frequency with respect to the previous frequency is negative, the polarity of the residual value is negative (−).

For example, the power reception device 100 calculates a first residual value between a first count value of a first time interval and a second count value of a second time interval, and a second residual value between a second count value of a second time interval and a third count value of a third time interval. When polarities of the first and second residual values are the same, the power reception device 100 may determine the input signal as a transmission power signal based on a frequency dithering operation, and when the polarities of the first and second residual values are different, the power reception device 100 may determine the input signal as a data signal.

For example, when the polarity of each of the first residual value and the second residual value is positive or the polarity of each of the first residual value and the second residual value is negative, the power reception device 100 may determine the corresponding input signal as a transmission power signal based on a frequency dithering operation. In addition, the power reception device 100 may determine the input signal as a data signal when the polarity of the first residual value is positive and the polarity of the second residual value is negative or when the polarity of the first residual value is negative and the polarity of the second residual value is positive.

In FIG. 12A, a transmission power signal based on a frequency dithering operation may continuously increase or decrease a count value over time (e.g., twice or more). On the contrary, referring to FIG. 12B, the count value of the data signal over time may not increase or decrease by two times or more.

In FIG. 12A, the power reception device 100 may calculate a first residual value between a count value CNT_a1 of a time interval a1 and a count value CNT_a2 of a time interval a2, and a second residual value between the count value CNT_a2 of the time interval a2 and a count value CNT_a3 of a time interval a3, and determine a corresponding input signal as a transmission power signal based on a frequency dithering operation when polarity of the first residual value is the same as polarity of the second residual value.

In FIG. 12B, the power reception device 100 may calculate a first residual value between a count value CNT_b1 of a time interval b1 and a count value CNT_b2 of a time interval b2, and a second residual value between the count value CNT_b2 of the time interval b2 and a count value CNT_b3 of a time interval b3, and determine a corresponding input signal as a data signal when polarity of the first residual value is not the same as polarity of the second residual value.

Furthermore, the present disclosure is not limited to three count values, and in some implementations, the power reception device 100 may determine, based on a polarity change of N−1 residual values for consecutive N count values, whether the input signal INPUT SIGNAL is a data signal or a transmission power signal based on the frequency dithering operation of the wireless power transmission device 200. Here, N may be a positive integer greater than or equal to 3.

For example, when the polarities of the N−1 residual values are all the same, the power reception device 100 may determine the input signal as a transmission power signal based on a frequency dithering operation, and when the polarities of the N−1 residual values are all different, the input signal may be determined as a data signal.

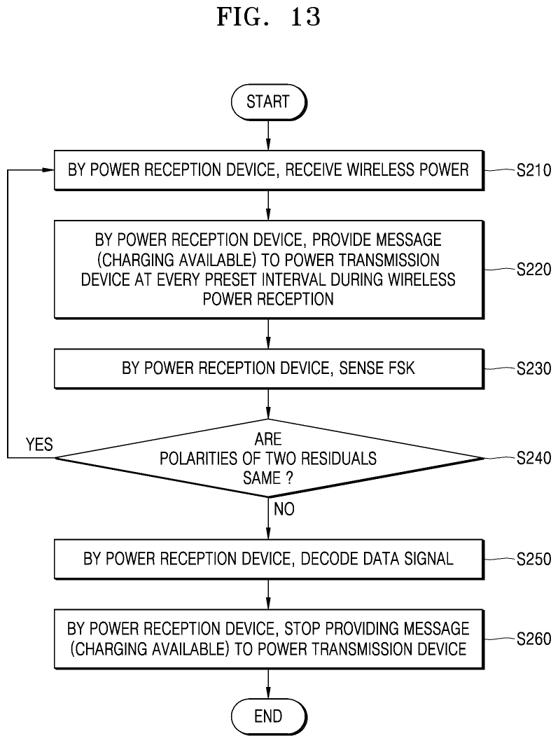

FIG. 13 is a flowchart illustrating an example of an operation of a wireless power transceiving system according to some implementations. In FIG. 13, in operation S210, the power reception device 100 may receive wireless power from the power transmission device 200.

In operation S220, the power reception device 100 may provide a message CHARGING AVAILABLE to the power transmission device 200 at every preset interval during wireless power reception.

In operation S230, the power reception device 100 may sense a frequency change of wireless power (or the input signal INPUT SIGNAL).

In operation S240, the power reception device 100 may determine, based on a polarity change of two residual values for three consecutive count values for the wireless power transmission signal, whether the input signal INPUT SIGNAL is a data signal or a transmission power signal based on a frequency dithering operation of the wireless power transmission device 200. Operation S240 of FIG. 13 may correspond to operation S123 of FIG. 11.

When the input signal INPUT SIGNAL is determined as a transmission power signal based on a frequency dithering operation of the power transmission device 200 (i.e., when the polarities of the two residual values are the same), the wireless power transceiving system may perform operation S210 again. That is, the power reception device 100 may keep receiving wireless power from the power transmission device 200.

When the input signal INPUT SIGNAL is determined as the data signal (i.e., when the polarities of the two residual values are different), the wireless power transceiving system may perform operation S250.

In operation S250, the power reception device 100 may perform a decoding operation (for example, an FSK decoding operation) on the data signal.

In operation S260, the power reception device 100 may stop providing a predetermined message CHARGING AVAILABLE to the power transmission device 200 during wireless power reception in order to stably perform the FSK decoding operation on the input signal INPUT SIGNAL. As the power transmission device 200 does not receive the message CHARGING AVAILABLE within the preset time interval, the power transmission device 200 may end the providing of wireless power to the power reception device 100.

According to some implementations, the power reception device 100 may improve the FSK demodulation stability of the FSK decoding operation by clearly distinguishing a transmission power signal based on a frequency dithering operation of the power transmission device 200 from a data signal in which data is modulated.

According to some implementations, the power reception device 100 may clearly distinguish between a transmission power signal based on a frequency dithering operation of the power transmission device 200 and a data signal in which data is modulated, thereby preventing in advance a case in which the power reception device 100 misrecognizes a transmission power signal based on a frequency dithering operation as a data signal in which data is modulated. Accordingly, the power reception device 100 may improve the stability of receiving the required transmission power by preventing in advance the case where the power reception device 100 performs an incorrect data decoding operation and fails to receive the required transmission power.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A method of operating a wireless power reception device configured to receive a data signal or wireless power from a wireless power transmission device, the method comprising:
receiving, by the wireless power reception device, an input signal from the wireless power transmission device; and
determining, by the wireless power reception device, that the input signal is a data signal or a transmission power signal based on a polarity of the input signal with respect to a frequency change,
wherein the polarity indicates a change amount between a previous frequency of the input signal and a corresponding frequency.

2. The method of claim 1, further comprising:
receiving, by the wireless power reception device, the wireless power from the wireless power transmission device; and
maintaining the wireless power reception device in a mode of receiving wireless power from the wireless power transmission device in response to determining that the input signal is a transmission power signal.

3. The method of claim 1, further comprising, in response to determining that the input signal is a data signal, performing, by the wireless power reception device, a decoding operation on the input signal by the wireless power reception device.

4. The method of claim 1, wherein determining that the input signal is a data signal or a transmission power signal comprises:
obtaining a plurality of count values; and
determining that the input signal is a data signal or a transmission power signal based on a polarity change of two residual values for three consecutive count values,
wherein each of the count values corresponds to a frequency of the input signal in a preset time interval.

5. The method of claim 4, wherein the determining that the input signal is a data signal or a transmission power signal comprises:
calculating a first residual value between a first count value of a first time interval and a second count value of a second time interval and a second residual value between a second count value of a second time interval and a third count value of a third time interval; and
determining that the input signal as a transmission power signal when a polarity of the first residual value is the same as a polarity of the second residual value.

6. The method of claim 5, wherein the determining that the input signal is a data signal or a transmission power signal comprises determining that the input signal is a data signal when a polarity of the first residual value differs from a polarity of the second residual value.

7. The method of claim 1, wherein determining that the input signal is a data signal or a transmission power signal comprises:
obtaining a plurality of count values; and
determining that the input signal is a data signal or a transmission power signal based on a polarity change of (N−1) residual values for N consecutive count values,
wherein each of the count values corresponds to a frequency of the input signal in a preset time interval, where N is a positive integer of 3 or more.

8. A method of operating a wireless power transceiving system that includes a wireless power transmission device and a wireless power reception device, the method comprising:
receiving, by the wireless power reception device, an input signal from the wireless power transmission device; and
determining, by the wireless power reception device, that the input signal is a data signal or a transmission power signal based on a polarity of the input signal with respect to a frequency change.

9. The method of claim 8, further comprising:
receiving, by the wireless power reception device, wireless power from the wireless power transmission device; and
maintaining the wireless power reception device in a mode of receiving wireless power from the wireless power transmission device in response to determining that the input signal is a transmission power signal.

10. The method of claim 8, further comprising, in response to determining that the input signal is a data signal, performing, by the wireless power reception device, a decoding operation on the input signal.

11. The method of claim 8, wherein determining that the input signal is a data signal or a transmission power signal comprises:
obtaining a plurality of count values; and
determining that the input signal is a data signal or a transmission power signal based on a polarity change of two residual values for three consecutive count values,
wherein each of the count values corresponds to a frequency of the input signal in a preset time interval.

12. The method of claim 11, wherein the determining that the input signal is a data signal or a transmission power signal comprises:
calculating a first residual value between a first count value of a first time interval and a second count value of a second time interval and a second residual value between a second count value of a second time interval and a third count value of a third time interval; and
determining the input signal as a transmission power signal when a polarity of the first residual value is the same as a polarity of the second residual value.

13. The method of claim 12, wherein determining that the input signal is a data signal or a transmission power signal comprises determining that the input signal is a data signal when a polarity of the first residual value differs from a polarity of the second residual value.

14. The method of claim 8, wherein the determining that the input signal is a data signal or a transmission power signal comprises:
obtaining a plurality of count values, wherein the count values correspond to a frequency of the input signal in a preset time interval; and
determining that the input signal is a data signal or a transmission power signal based on a polarity change of (N−1) residual values for N consecutive count values, where N is a positive integer of 3 or more.

15. A wireless power reception device configured to receive a data signal or wireless power from a wireless power transmission device, the wireless power reception device comprising:
a communication circuit configured to receive an input signal from the wireless power transmission device; and
a frequency shift keying (FSK) detection circuit configured to determine that the input signal is a data signal or a transmission power signal based on a polarity of the input signal with respect to a frequency change.

16. The wireless power reception device of claim 15, wherein the wireless power reception device is configured to:
receive wireless power from the wireless power transmission device; and
maintain receiving wireless power in response to a determination that the input signal is a transmission power signal.

17. The wireless power reception device of claim 15, wherein the wireless power reception device is configured to perform a decoding operation on the input signal, in response to a determination that the input signal is a data signal.

18. The wireless power reception device of claim 15, wherein the FSK detection circuit is configured to:
obtain a plurality of count values; and
determine that the input signal is a data signal or a transmission power signal based on a polarity change of two residual values for three consecutive count values,
wherein each of the count values corresponds to a frequency of the input signal in a preset time interval.

19. The wireless power reception device of claim 18, wherein the FSK detection circuit is configured to:
calculate a first residual value between a first count value of a first time interval and a second count value of a second time interval and a second residual value between a second count value of a second time interval and a third count value of a third time interval; and
determine that the input signal is a transmission power signal based on a polarity of the first residual value being the same as a polarity of the second residual value.

20. The wireless power reception device of claim 15, wherein the FSK detection circuit is configured to:
obtain a plurality of count values; and
determine that the input signal is a data signal or a transmission power signal based on a polarity change of (N−1) residual values for N consecutive count values,
wherein each of the count values corresponds to a frequency of the input signal in a preset time interval, where N is a positive integer of 3 or more.
